(19) United States
(12) Patent Application Publication
(10) Pub. No.: US 2006/0080090 A1
(43) Pub. Date: Apr. 13, 2006

(54) Reusing codebooks in parameter quantization

(75) Inventors: Anssi Ramo, Tampere (FI); Sakari Himanen, Tampere (FI); Jani Nurminen, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/961,471

(22) Filed: Oct. 7, 2004

(51) Int. Cl. G10L 19/12

(52) U.S. Cl. 704/222

(57) ABSTRACT

The present invention provides a new methodology for reusing codebooks for a multistage vector quantization of parameter quantizers of signals. Prior art multistage vector quantization is done in such a way that each stage has different optimized codebooks. The prior art codebooks, thus, use quite a lot of a memory storage space. Using the same codebook stages several times, according to the present invention, reduces the memory usage and a codebook structure maintains good quality by using optimized codebooks for the most important (first) stages in the quantization. The number of codebooks is reduced by reusing the same codebooks in the refining stages. Additionally, according to the present invention, using many predictors is space-wise efficient since they need only a few of coefficients instead of larger codebooks.

### TECHNICAL FIELD

This invention generally relates to coding in communication systems and more specifically to reusing codebooks in parameter quantization of signals.

### BACKGROUND ART

Speech and audio coding algorithms have a wide variety of applications in communication, multimedia and storage systems. The development of the coding algorithms is driven by the need to save transmission and storage capacity while maintaining a high quality of a synthesized signal. The complexity of a coder is limited by the processing power of the application platform. In some applications, e.g., a voice storage, an encoder may be highly complex, while the decoder can be as simple as possible.

In a typical speech coder, the input speech signal is processed in segments, which are called frames. Usually the frame length is 10-30 ms, and a look ahead segment of 5-15 ms of the subsequent frame is also available. The frame may further be divided into a number of sub-frames. For every frame, the encoder 10a in FIG. 1 determines a parametric representation of the input signal. The parameters are quantized and transmitted through a communication channel or stored in a storage medium in a digital form. At the receiving end, the decoder constructs a synthesized signal based on the received parameters as shown in FIG. 1. The quantization and the construction of the parameters require codebooks, which contain vectors optimized for a quantization task. Often higher compression ratios require highly optimized codebooks occupying a lot of a memory space.

Most current speech coders include a linear prediction (LP) filter, for which an excitation signal is generated. The LP filter has typically an all-pole structure described by

$$\frac{1}{A ( z )} = \frac{1}{1 + {a}_{1} {z}^{- 1} + {a}_{2} {z}^{- 2} + … + {a}_{p} {z}^{- p}} ,$$

where a₁, a₂, . . . , aₚ are LP coefficients. The degree p of the LP filter is usually 8-12. The input speech signal is processed in frames. For each speech frame, the encoder determines the LP coefficients using, e.g., the Levinson-Durbin algorithm. Line spectrum frequency (LSF) representation is employed for quantization of the coefficients, because they have good quantization properties. For intermediate sub-frames, the coefficients are linearly interpolated using the LSF representation.

In order to define the LSFs, an inverse LP filter A(z) polynomial is used to construct two polynomials as described by K. K. Paliwal and B. S. Atal, in “Efficient Vector Quantization of LPC Parameters at 24 bits/frame”, Proceedings of ICASSP-91, pp. 661-664, as follows:
P(z)=A(z)+z^{-(p+1)}A(z⁻¹), and
Q(z)=A(z)−z^{-(p+1)}A(z⁻¹).

The roots of the polynomials P(z) and Q(z) are called LSFs. The polynomials P(z) and Q(z) have the following properties: 1) all zeros (roots) of the polynomials are on the unit circle, 2) the zeros of P(z) and Q(z) are interlaced with each other. More specifically, the following relationship is always satisfied:
0=ω₀<ω₁<ω₂< . . . <ωₚ₋₁<ωₚ<ωₚ₊₁=π.

The ascending ordering guarantees the filter stability, which is often required in signal coding applications. It is noted that the first and last parameters are always zero and π, respectively, and only p values has to be transmitted as described by N. Sugamura and N. Farvardin, in “Quantizer Design in LSP Speech Analysis and Synthesis”, Proceedings of ICASSP-88, pp. 398-401.

In speech coders an efficient representation is needed for storing LSF information. The most efficient way to quantize the LSF parameters is to use vector quantization (VQ) often together with prediction as described, for example, by A. McCree and J. C. De Martin, “A 1.7 kb/s MELP Coder with Improved Analysis and Quantization”, in Proceedings of ICASSP-98, pp. 593-596. Usually predicted values are estimated based on the previously decoded output values, e.g., in case of an autoregressive predictor (AR-predictor) or based on previously quantized values, e.g., in case of a moving average predictor (MA-predictor), as follows

$${pLSF}_{k} = mLSF + {\sum }_{j = 1}^{m} {A}_{j} ( {qLSF}_{k - j} - mLSF ) + {\sum }_{i = 1}^{n} {B}_{i} {CB}_{k - i} ,$$

where Aⱼs and Bᵢs are predictor matrixes and m and n are orders of the AR- and MA-predictors, respectively. mLSFₖ is a mean LSF, qLSFₖ is a quantized LSF, CBₖ is a codebook vector for the frame k. State of the art quantization uses several switched predictors. Predictor selection is transmitted in that case with one or more bits. This is efficient since the bit used in a predictor selection is often more efficient than making the codebooks larger. Especially in space-constrained cases it is efficient to use the bits for the predictor selection since adding the bits to codebooks doubles the code book stage size, but using a new diagonal predictor requires only p values (commonly 10).

Codebooks are optimized for each predictor separately and stored, e.g., in a ROM memory. If several predictors and/or large codebooks are used, a lot of storage memory is required. By using smaller/fewer codebooks, the memory consumption can be reduced but at the expense of a reduced compression performance. Using its own optimized codebooks for each quantizer stage requires a lot of storage space as well. It is highly desirable to find an efficient solution to obviate the problem of a required large storage space.

### DISCLOSURE OF THE INVENTION

The object of the present invention is to provide a methodology for reusing codebooks for a multistage vector quantization of parameter quantizers of signals.

According to a first aspect of the invention, a method of reusing codebooks for a multistage vector quantization of parameter quantizers for a signal, comprises the steps of: training multistage vector quantization codebooks for all predictor and non-predictor modes of the parameter quantizers; analyzing the trained codebooks for different stages of the vector quantization and optionally analyzing corresponding training data used for the training and identifying similar codebooks corresponding to different predictor and non-predictor modes out of the all predictor and non-predictor modes for the different stages based on the analyzing using a predetermined criterion; combining the training data corresponding to N codebooks selected from the similar codebooks based on a further predetermined criterion; and training the N codebooks using the combined training data thus generating a new common codebook to be used instead of the N codebooks for the multistage vector quantization of the parameter quantizers for the signal, wherein N is an integer of at least a value of two.

According further to the first aspect of the invention, the step of the training multistage vector quantization codebooks may include training predictors corresponding to the all predictor modes of the parameter quantizers.

According further still to the first aspect of the invention, the steps of the analyzing the combining and the training may be repeated until a pre-selected level of memory space savings is reached.

According yet further still to the first aspect of the invention, the N codebooks may have the same size.

Yet still further according to the first aspect of the invention, the identifying similar codebooks using the predetermined criterion may be based on evaluating a variance of related parameters, and optionally on evaluating the variance of training vectors or code vectors, corresponding to the similar codebooks.

Further according to the first aspect of the invention, the step of the analyzing the trained codebooks may include evaluating at least one related parameter for an original codebook out of the trained codebooks for one predictor mode of the all predictor modes, and then evaluating at least one related parameter using a different trained codebook out of the trained codebooks for a different predictor mode of the all predictor modes in place of the original trained codebook and using identical data for the both evaluatings.

Still yet further according to the first aspect of the invention, the step of the combining the training data may include combining the training data for the original codebook and the different codebook if the predetermined criterion is met.

Further according to the first aspect of the invention, the parameter quantizers may contain both vector and scalar parameters.

Still further still according to the first aspect of the invention, the training the N codebooks using the combined training data may be performed using a pre-selected algorithm, optionally a generalized Lloyd algorithm.

Still further according to the first aspect of the invention, all steps may be performed by an encoder of a communication system, and the encoder optionally may be a part of a mobile device which is optionally a mobile phone. Further, the encoder may be capable of storing the common codebooks and may be capable of generating an encoded quantized signal from the signal by using and reusing the common codebook for the multistage vector quantization of the parameter quantizers for the signal.

According to a second aspect of the invention, an encoder capable of reusing codebooks for a multistage vector quantization of parameter quantizers for a signal, comprises: a means for training multistage vector quantization codebooks for all predictor and non-predictor modes of the parameter quantizers; an analyzing block, for analyzing the trained codebooks for different stages of the vector quantization and optionally analyzing corresponding training data used for the training and identifying similar codebooks corresponding to different predictor and non-predictor modes out of the all predictor and non-predictor modes for the different stages based on the analyzing using a predetermined criterion; and a combining block, for combining the training data corresponding to N codebooks selected from the similar codebooks based on a further predetermined criterion; and means for training the N codebooks using the combined training data thus generating a new common codebook to be used instead of the N codebooks for the multistage vector quantization of the parameter quantizers for the signal, wherein N is an integer of at least a value of two.

According further to the second aspect of the invention, the training multistage vector quantization codebooks may also include training predictors corresponding to the all predictor modes of the parameter quantizers.

According still further to the second aspect of the invention, the analyzing the trained codebooks, the combining the training data and the training the N codebooks may be repeated until a pre-selected level of memory space savings is reached.

According further still to the second aspect of the invention, the N codebooks may have the same size.

Yet still further according to the second aspect of the invention, the identifying similar codebooks using the predetermined criterion may be based on evaluating a variance of related parameters, and optionally on evaluating the variance of training vectors corresponding to the similar codebooks.

Further according to the second aspect of the invention, analyzing the trained codebooks may include evaluating at least one related parameter for an original codebook out of the trained codebooks for one predictor mode of the all predictor modes, and then evaluating at least one related parameter using a different trained codebook out of the trained codebooks for a different predictor mode of the all predictor modes in place of the original trained codebook and using identical data for the both evaluatings. Further, the combining the training data may include combining the training data for the original codebook and the different codebook if the predetermined criterion is met.

Still further according to the second aspect of the invention, the parameter quantizers may contain both vector and scalar parameters.

Yet still further according to the second aspect of the invention, the encoder may be a part of a communication system or a part of a mobile device which is optionally a mobile phone.

Still yet further according to the second aspect of the invention, the means for training the multistage vector quantization codebooks and the means for training the N codebooks using the combined training data may be incorporated in one block.

Still further still according to the second aspect of the invention, the encoder may further comprise: a memory, for storing the common codebook; and a coding module, capable of retrieving the common codebook from the memory for generating an encoded quantized signal from the signal by using and reusing the common codebook for the multistage vector quantization of the parameter quantizers for the signal.

According to a third aspect of the invention, a computer program product may comprise: a computer readable storage structure embodying computer program code thereon for execution by a computer processor with the computer program code characterized in that it may include instructions for performing the steps of the method of the first aspect of the invention indicated as being performed by any component or a combination of components of the encoder.

Quantization performance remains good while the codebook sizes can be reduced significantly. The result is smaller size encoder and decoder. The size is very important especially in embedded applications such as mobile phones.

### BRIEF DESCRIPTION OF THE DRAWINGS

For a better understanding of the nature and objects of the present invention, reference is made to the following detailed description taken in conjunction with the following drawings, in which:

FIG. 1 is a block diagram demonstrating digital transmission and storage of speech and audio signals in a communication system, according to the prior art;

FIG. 2 is a block diagram of an encoder of a communication system, according to the present invention;

FIG. 3 is a flow chart demonstrating one example of generating common codebooks used for a multistage vector quantization of signal parameters by reusing codebooks, according to the present invention; and

FIG. 4 is a flow chart demonstrating another example of generating common codebooks used for a multistage vector quantization of signal parameters by reusing codebooks, according to the present invention.

### BEST MODE FOR CARRYING OUT THE INVENTION

The present invention provides a new methodology for reusing codebooks for a multistage vector quantization of parameter quantizers of signals. According to the present invention, said parameter quantizers can be both vector and scalar parameters. Prior art multistage vector quantization is done in such a way that each stage has different optimized codebooks. Therefore the prior art codebooks use quite a lot of a memory storage space. Using the same codebook stages several times, according to the present invention, reduces the memory usage and a codebook structure maintains good quality by using optimized codebooks for the most important (first) stages in the quantization. The number of codebooks is reduced by reusing the same codebooks in the refining stages. Additionally, according to the present invention, using many predictors is space-wise efficient since they need only a few coefficients instead of larger codebooks.

In a practical implementation the codebook design/training has to be carefully implemented. Best results are obtained when the first stages in all multistage quantizers are optimal for predicted data (i.e., the first stage should have a unique codebook). This is important since in many multistage quantizers the first stages take out most of the error energy (i.e. the codebooks are designed so that the first stage codebooks have most variance and consequently most resolving power).

One possibility (first scenario) among many others, according to the present invention is to combine codebooks as follows:
1. Train the MSVQ codebooks for all predictors in the conventional manner using, for example, a simultaneous joint design algorithm as described by W. P. LeBlanc, B. Bhattacharya, S. A. Mahmoud & V. Cuperman, in “Efficient Search and Design Procedures for Robust Multi-Stage VQ of LPC Parameters for 4 kb/s Speech Coding”, IEEE Transactions on Speech and Audio Processing 1, 4 (1993). pp. 373-385;
2. Analyze the resulting codebooks and the used training data for different predictors and determine if the data behavior (variance/energy) is similar enough for combining the training data based on a predetermined criterion;
3. Identify similar codebooks and combine training data for these similar codebooks based on a further predetermined criterion;
4. Train the similar codebooks using the new combined training data; and
5. If further memory space savings are needed, go back to step 2 and continue.

Another possibility (second scenario) among many others is to combine codebooks with the following method:
1. Train the MSVQ codebooks for all predictors in the conventional manner using, for example, a simultaneous joint design algorithm as described by W. P. LeBlanc, B. Bhattacharya, S. A. Mahmoud & V. Cuperman, in “Efficient Search and Design Procedures for Robust Multi-Stage VQ of LPC Parameters for 4 kb/s Speech Coding”, IEEE Transactions on Speech and Audio Processing 1, 4 (1993). pp. 373-385;
2. Identify same-size codebooks for different predictors.
3. Evaluate each of these codebooks by using every other similar sized codebook in its place with the same test (training) data; from the results it can be identified which codebooks are closest to each other;
4. Combine the training data for at least two “similar” stage codebooks identified in step 3;
5. Train the optimized similar codebook using, for example, the generalized Lloyd algorithm (e.g., see A. Gersho, R. M. Gray, Vector Quantization and Signal Compression, Kluwer Academic publishers 1992, pp.188-190); and
6. If further memory space savings are needed, go back to step 2 and continue.

After performing the algorithms for combining codebooks described above, the actual vector quantization by reusing the same codebooks is performed exactly the same way as the usual switched prediction (see e.g., A. McCree and J. C. De Martin, “A 1.7 kb/s MELP Coder with Improved Analysis and Quantization”, in Proceedings of ICASSP-98, pp. 593-596), and, e.g., as summarized below:
1. A quantization error is calculated for all cases using different predictors and their codebooks, which now (after combining codebooks) contain common stages;
2. A minimal error producing predictor and codebook indices are sent to a receiver; and
3. Predictor memories are updated.

FIGS. 2 through 4 and an example case shown in Table 1 below demonstrate different implementation alternatives of the present invention.

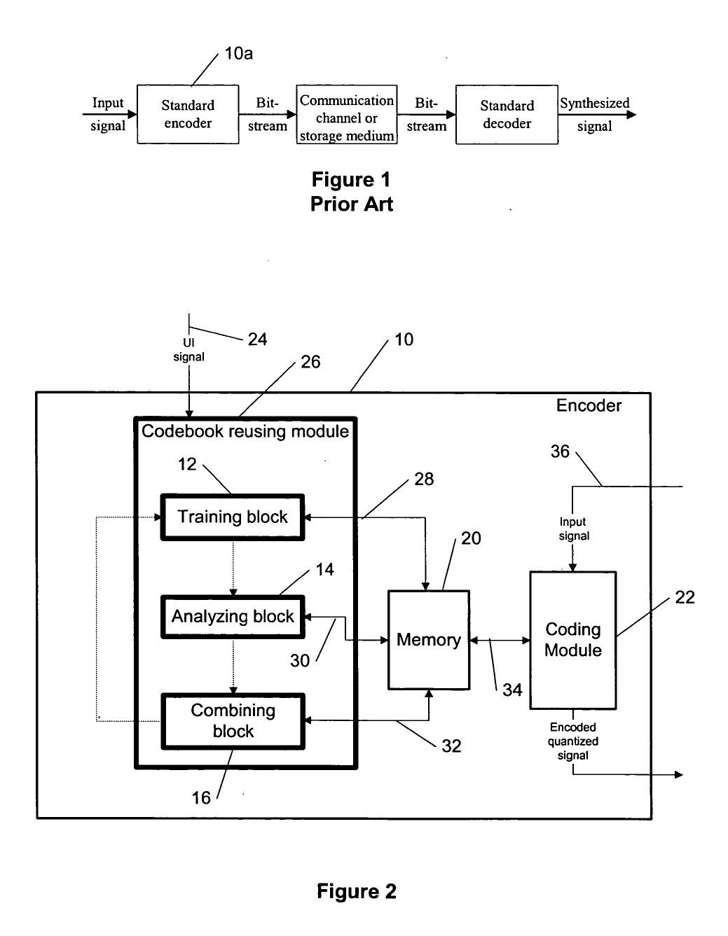

FIG. 2 is an example among others of a block diagram of an encoder 10 of a communication system (e.g., shown in FIG. 1), according to the present invention.

In addition to standard operating blocks such as a coding module 22 (e.g., for encoding and quantizing signal parameters of an input signal 36) and a memory 20 (e.g., for storing codebooks, training data, predictors, etc.), the encoder 10 contains an additional block, a codebook reusing module 26, for implementing training, analyzing and combining functions for reusing the codebooks for the multistage vector quantization of the parameter quantizers, according to the present invention. It is noted that, in an alternative implementation of the present invention, the codebook reusing module 26 can be located outside of the encoder 10. For example, the codebooks can be trained off-line on a PC and only the trained codebooks are then stored in the memory 20.

A training block 12 of the codebook reusing module 26 is for training multistage vector quantization codebooks for all predictor and non-predictor modes of said parameter quantizers (see step 1 in the first and second scenarios above). This function of the block 12 can be alternatively performed by a similar training block in the standard coding module 22. The training block 12 can also be used for re-training of similar codebooks (see step 5 in the first and second scenarios above) as discussed below in detail.

An analyzing/evaluating block 14 of the codebook reusing module 26 is for analyzing/evaluating the trained codebooks for different stages of the vector quantization (e.g., step 2 in the first scenario above and steps 2 and step 3 in the second scenario above) and optionally analyzing/evaluating corresponding training data used for said training (e.g., step 2 in the first scenario above) and identifying similar codebooks corresponding to different predictor and non-predictor modes out of said all predictor and non-predictor modes for said different stages based on said analyzing/evaluating using a predetermined criterion.

A combining block 16 of the codebook reusing module 26 is for combining the training data corresponding to N codebooks selected from said similar codebooks based on a further predetermined criterion. After completing this operation, the process moves to the training block 12, described above, for training the N codebooks using said combined training data, thus generating a new common codebook which is used instead of said N codebooks for said multistage vector quantization of said parameter quantizers for said signals, wherein N is an integer of at least a value of two.

Dotted arrow lines in the codebook reusing module 26 indicate logical directions of the process. Lines 28, 30 and 32 facilitate exchange of information to/from the blocks 12, 14 and 16 from/to the memory 20. Similarly a line 34 is used for communicating between the memory 20 and the coding module 22. For example, the training block 12 retrieves said N codebooks and said combined training data from the memory 20 (where they are stored after completing the combining procedure by the combining block 16 as described above) and then after completing the training procedure, the training block 12 sends the new common codebook to memory 20 for storage and for further using by the coding module 22 for encoding and quantizing signal parameters of an input signal 36 as mentioned above. A UI (user interface) signal 24 is used for sending appropriate commands to the codebook reusing module 26 regarding all or selected steps of the first and second scenarios described above.

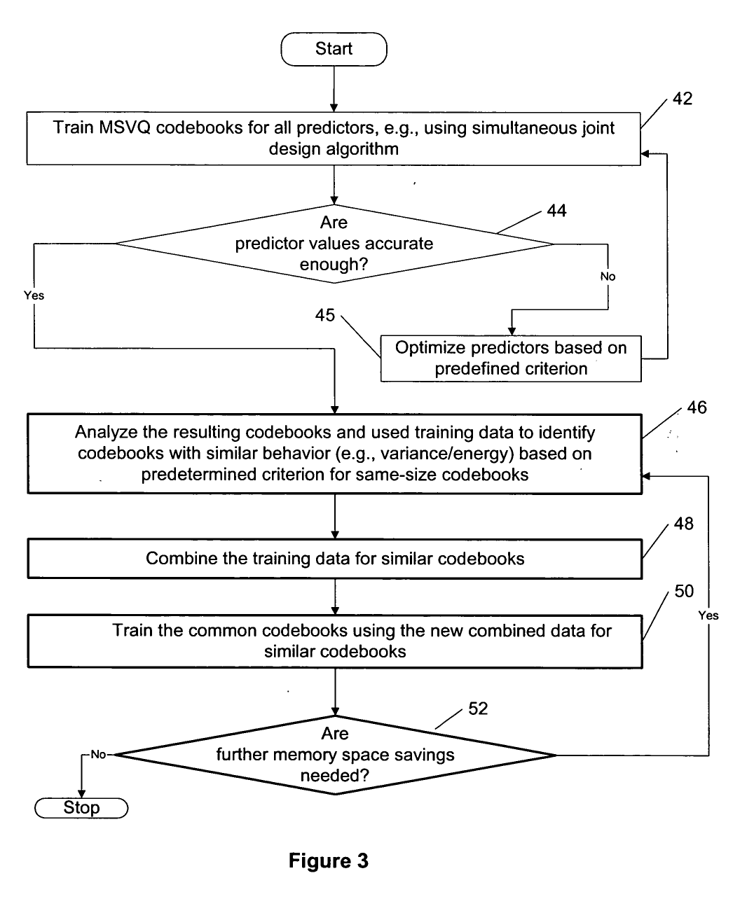

FIG. 3 shows a flow chart demonstrating one example of generating common codebooks used for a multistage vector quantization of signal parameters by reusing codebooks, according to the present invention. This procedure corresponds to the first scenario described above.

The flow chart of FIG. 3 only represents one possible scenario among many others. In a method according to the present invention, in a first step 42, the multistage vector quantization codebooks for all predictor and non-predictor modes of said parameter quantizers are trained, e.g., using the simultaneous joint design algorithm. The training of the step 42 can also involve simultaneous training of the predictors. To accomplish that, in a step 44, it is determined whether predictor values are accurate enough. If that is the case, the process goes to step 46. However, if it is determined that a further adjustment is required for the predictor values based on a predefined criterion, in a next step 45, the predictors are optimized based on that predefined criterion. The resulting codebooks along with the predictors and the corresponding training data are stored in the memory 20 as shown in FIG. 2.

In a next step 46, the resulting codebooks and the used training data are analyzed (e.g., by the analyzing/evaluating block 14 of FIG. 2) to identify codebooks with similar behavior (e.g., variance/energy) based on a predetermined criterion for same-size codebooks. For example, identifying similar codebooks using said predetermined criterion can be based on evaluating a variance of related parameters such as the variance of training vectors, or the variance of code vectors corresponding to said similar codebooks.

In a next step 48, the training data, corresponding to N codebooks selected from said identified codebooks with similar behavior based on the further predetermined criterion, are combined (e.g., using the combining block 16 of FIG. 2), wherein N is an integer of at least a value of two. In a next step 50, the N chosen codebooks are trained (e.g., using the training block 12 of FIG. 2) using said combined training data thus generating a new common codebook which is used instead of said N codebooks for said multistage vector quantization of said parameter quantizers for said signal. Finally, in a step 52, it is determined if further memory space savings are needed. If that is not the case, the process stops. If, however, it is determined that the memory space savings are needed, the process goes back to step 54.

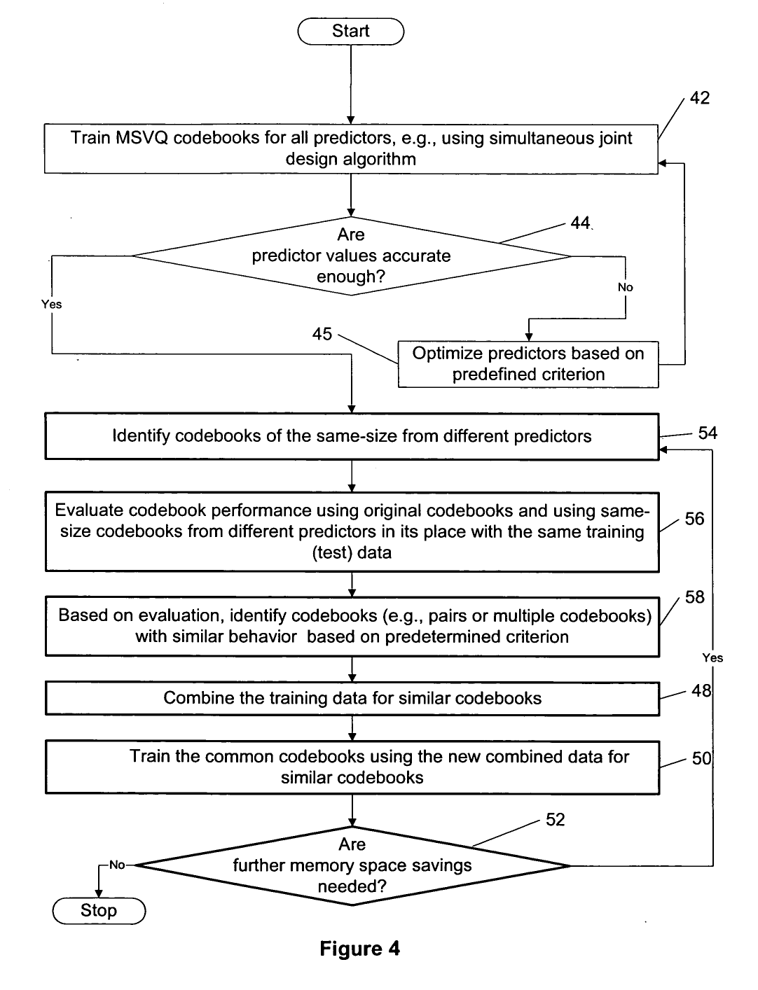

FIG. 4 shows a flow chart demonstrating another example of generating common codebooks used for a multistage vector quantization of signal parameters by reusing codebooks, according to the present invention.

The flow chart of FIG. 4 only represents one possible scenario among many others. Starting steps 42, 44 and 45 are the same as in the example of FIG. 3. In a method according to the present invention, in a step 54 following steps 44 and 45, the codebooks of the same-size from different predictors are identified. In a next step 56, the codebook performance is evaluated using original codebooks and using same-size codebooks from different predictors in its place with the same training (test) data. In a next step 58, codebooks with similar behavior based on predetermined criterion are identified. The last step is followed by steps 48, 50 and 52 which are the same as in FIG. 3 and are described above.

The following example further demonstrates the present invention. In a very low bit rate coder there are four modes: no audio, unvoiced, mixed voiced and fully voiced. All but the no-audio segments require LSF parameter quantization. In all cases a switched prediction is used. In the unvoiced and mixed voicing cases a two-predictor model is used. In the fully voiced case four different predictors are used. The bit-allocation, modes and codebook reuse (UCB Unique CodeBook, CCB Common CodeBook) can be seen in Table 1 (results are generated using the first scenario described above).

TABLE 1

| | | Total | | Codebook names |
|---|---|---|---|---|
| Segment | | bit | Bits (predictor | (Highlighted |
| mode | | usage | and VQ stages) | are reused) |
| No audio | — | 0 | | |
| Unvoiced | No | 14 | 1, 4, 4, 5 | UCB11, UCB12, |
| | prediction | | | CCB1 |
| | AR-predictor | 6 | 1, 5 | CCB1 |
| Mixed | No | 28 | 1, 5, 5, 5, 4, 4, 4 | UCB21, UCB22, |
| voiced | prediction | | | CCB1, CCB2, |
| | | | | CCB3, CCB4 |
| | AR- | 18 | 1, 5, 4, 4, 4 | UCB31, CCB2, |
| | prediction | | | CCB3, CCB4 |
| Fully | No | 31 | 2, 4, 4, 4, 5, 4, 4, 4 | UCB41, UCB42, |
| voiced | prediction | | | UCB43, CCB1, |
| | | | | CCB2, CCB3, |
| | | | | CCB4 |
| | Strong AR- | 18 | 2, 4, 4, 4, 4 | CCB2, CCB3, |
| | prediction | | | CCB4, CCB5 |
| | Milder AR- | 23 | 2, 4, 5, 4, 4, 4 | UCB51, CCB1, |
| | prediction | | | CCB2, CCB3, |
| | | | | CCB4 |
| | Mildest AR- | 23 | 2, 4, 5, 4, 4, 4 | UCB61, CCB1, |
| | prediction | | | CCB2, CCB3, |
| | | | | CCB4 |

As can be seen, 57% space savings are obtained. Without a space reuse, a memory usage would have been 10*2*(9*2ˆ5+26*2ˆ4)=14080 bytes with 16 bit coefficients. Now it is only 10*2*(4*2ˆ5+11*2ˆ4)=6080 bytes. Five Common CodeBooks have replaced 25 Unique CodeBooks.

What is claimed is:

1. A method of reusing codebooks for a multistage vector quantization of parameter quantizers for a signal, comprising the steps of:
training multistage vector quantization codebooks for all predictor and non-predictor modes of said parameter quantizers;
analyzing said trained codebooks for different stages of said vector quantization and optionally analyzing corresponding training data used for said training and identifying similar codebooks corresponding to different predictor and non-predictor modes out of said all predictor and non-predictor modes for said different stages based on said analyzing using a predetermined criterion;
combining said training data corresponding to N codebooks selected from said similar codebooks based on a further predetermined criterion; and
training said N codebooks using said combined training data thus generating a new common codebook to be used instead of said N codebooks for said multistage vector quantization of said parameter quantizers for said signal, wherein N is an integer of at least a value of two.

2. The method of claim 1, wherein the step of said training multistage vector quantization codebooks also include training predictors corresponding to said all predictor modes of said parameter quantizers.

3. The method of claim 1, wherein the steps of said analyzing said combining and said training are repeated until a pre-selected level of memory space savings is reached.

4. The method of claim 1, wherein said N codebooks have the same size.

5. The method of claim 1, wherein said identifying similar codebooks using said predetermined criterion is based on evaluating a variance of related parameters, and optionally on evaluating the variance of training vectors or code vectors, corresponding to said similar codebooks.

6. The method of claim 1, wherein the step of said analyzing said trained codebooks includes evaluating at least one related parameter for an original codebook out of said trained codebooks for one predictor mode of said all predictor modes, and then evaluating said at least one related parameter using a different trained codebook out of said trained codebooks for a different predictor mode of said all predictor modes in place of said original trained codebook and using identical data for said both evaluatings.

7. The method of claim 6, wherein the step of said combining said training data include combining said training data for said original codebook and said different codebook if said predetermined criterion is met.

8. The method of claim 1, wherein said parameter quantizers contain both vector and scalar parameters.

9. The method of claim 1, wherein said training said N codebooks using said combined training data is performed using a pre-selected algorithm, optionally a generalized Lloyd algorithm.

10. The method of claim 1, wherein all steps are performed by an encoder of a communication system, and said encoder optionally is a part of a mobile device which is optionally a mobile phone.

11. The method of claim 10, said encoder is capable of storing said common codebooks and capable of generating an encoded quantized signal from said signal by using and reusing said common codebook for said multistage vector quantization of said parameter quantizers for said signal.

12. A computer program product comprising: a computer readable storage structure embodying computer program code thereon for execution by a computer processor with said computer program code characterized in that it includes instructions for performing the steps of the method of claim 10 indicated as being performed by any component or a combination of components of said encoder.

13. An encoder capable of reusing codebooks for a multistage vector quantization of parameter quantizers for a signal, comprising:
means for training multistage vector quantization codebooks for all predictor and non-predictor modes of said parameter quantizers;
an analyzing block, for analyzing said trained codebooks for different stages of said vector quantization and optionally analyzing corresponding training data used for said training and identifying similar codebooks corresponding to different predictor and non-predictor modes out of said all predictor and non-predictor modes for said different stages based on said analyzing using a predetermined criterion; and
a combining block, for combining said training data corresponding to N codebooks selected from said similar codebooks based on a further predetermined criterion; and
means for training said N codebooks using said combined training data thus generating a new common codebook to be used instead of said N codebooks for said multistage vector quantization of said parameter quantizers for said signal, wherein N is an integer of at least a value of two.

14. The encoder of claim 13, wherein said training multistage vector quantization codebooks also include training predictors corresponding to said all predictor modes of said parameter quantizers.

15. The encoder of claim 13, wherein said analyzing said trained codebooks, said combining said training data and said training said N codebooks are repeated until a pre-selected level of memory space savings is reached.

16. The encoder of claim 13, wherein said N codebooks have the same size.

17. The encoder of claim 13, wherein said identifying similar codebooks using said predetermined criterion is based on evaluating a variance of related parameters, and optionally on evaluating the variance of training vectors corresponding to said similar codebooks.

18. The encoder of claim 13, wherein said analyzing said trained codebooks includes evaluating at least one related parameter for an original codebook out of said trained codebooks for one predictor mode of said all predictor modes, and then evaluating said at least one related parameter using a different trained codebook out of said trained codebooks for a different predictor mode of said all predictor modes in place of said original trained codebook and using identical data for said both evaluatings.

19. The encoder of claim 18, wherein said combining said training data include combining said training data for said original codebook and said different codebook if said predetermined criterion is met.

20. The encoder of claim 13, wherein said parameter quantizers contain both vector and scalar parameters.

21. The encoder of claim 13, wherein said encoder is a part of a communication system or a part of a mobile device which is optionally a mobile phone.

22. The encoder of claim 13, wherein said means for training said multistage vector quantization codebooks and said means for training said N codebooks using said combined training data are incorporated in one block.

23. The encoder of claim 13, further comprising:
a memory, for storing said common codebook; and
a coding module, capable of retrieving said common codebook from said memory for generating an encoded quantized signal from said signal by using and reusing said common codebook for said multistage vector quantization of said parameter quantizers for said signal.
